(19) United States
(12) Patent Application Publication
(10) Pub. No.: US 2010/0159822 A1
(43) Pub. Date: Jun. 24, 2010

(54) APPARATUS AND METHOD FOR PROVIDING MBMS IN WIRELESS COMMUNICATION SYSTEM

(75) Inventors: Soon-Yong LIM, Daejon (KR); Ae-Soon PARK, Daejon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejon (KR)

(21) Appl. No.: 12/555,596

(22) Filed: Sep. 8, 2009

(30) Foreign Application Priority Data
Dec. 19, 2008 (KR) 10-2008-0130519

(51) Int. Cl. H04H 40/00

(52) U.S. Cl. 455/3.06

(57) ABSTRACT

Provided is an apparatus and method for providing a Multimedia Broadcast and Multicast Service (MBMS) in a wireless communication system, e.g., a 3^{rd}-Generation Partnership Project (3GPP) Long-Term Evolution (LTE)-Advanced mobile communication system. The method for providing an MBMS in a mobile communication system includes: multiplexing MBMS traffic channels providing MBMS traffic data and an MBMS control channel proving control information of MBMS into a downlink-shared channel; processing and transmitting data of the downlink-shared channel to be transmitted through a physical downlink-shared channel of a physical channel; and generating and transmitting a physical downlink control channel which includes identifiers for indicating MBMS data and information to designate a receiving terminal of data transmitted through the physical downlink-shared channel.

### CROSS-REFERENCE TO RELATED APPLICATIONS

The present invention claims priority of Korean Patent Application No. 10-2008-0130519, filed on Dec. 19, 2008, which is incorporated herein by reference.

### BACKGROUND OF THE INVENTION

1. Field of the Invention

The present invention relates to an apparatus and method for providing Multimedia Broadcast and Multicast Service (MBMS) in a wireless communication system.

2. Description of Related Art

Generally, wireless communication systems have been developed to provide a communication service while securing mobility for users. A mobile communication system is the representative system among the wireless communication systems. The mobile communication system has been developed to be able to supply a high-speed data service from a low level of simply providing a voice service. To have a look at the service forms of the mobile communication system, there are various types of new services, from a type of a system for transmitting data between particular two users to a 1:M communication system for connecting a single user to multiple users and a system for providing data to a large number of users in a wireless communication system.

A Universal Mobile Telecommunications System (UMTS) or Multimedia Broadcast and Multicast Service (MBMS) system is one of the systems capable of providing a service to multiple users in the wireless communication system. Here, the MBMS has been proposed in 3^{rd} Generation Partnership Project (3GPP) Long-Term Evolution (LTE) standard and it discloses a system for controlling broadcast/multicast traffic in a base station Broadcasting/Multicasting Control (BMC) and wirelessly transmitting traffic data through a transport channel, e.g., forward access channel (FACH). Considering the characteristics of the FACH, the MBMS is appropriate only for broadcasting low-volume traffic data. The MBMS service has reached the level of actual service after many discussions and researches.

Meanwhile, a 3GPP LTE-Advanced system is an advanced model of the 3GPP and 3GPP LTE systems and it is now under discussion for standardization pursuing a high-capacity system. Therefore, it has a technical background that exceeds the bounds of the MBMS technology discussed in the previous 3GPP standards.

However, no specific method for providing MBMS are discussed in a mobile communication system based on the 3GPP LTE-Advanced standard. If any, single-cell and multi-cell transmission methods are defined and only an outline of each method has been laid out.

### SUMMARY OF THE INVENTION

Embodiments of the present invention are directed to providing an apparatus and method for providing a Multimedia Broadcast and Multicast Service (MBMS) in a wireless communication system, e.g., a 3^{rd}-Generation Partnership Project (3GPP) Long-Term Evolution (LTE)-Advanced mobile communication system.

In accordance with an aspect of the present invention, there is provided an apparatus for providing an MBMS in a mobile communication system, including: a multiplexer configured to multiplex MBMS traffic channels providing MBMS traffic data and an MBMS control channel providing control information of the MBMS into a downlink-shared channel; a scheduler configured to schedule transmission of the MBMS traffic data and the control information of the MBMS; a physical downlink-shared channel transmitting unit configured to process data of the physical downlink-shared channel to be transmitted through a physical downlink-shared channel of a physical channel; and a physical downlink control channel transmitting unit configured to generate and transmit a physical downlink control channel which includes identifiers for indicating MBMS data and information for designating a receiving terminal of data transmitted through the physical downlink-shared channel.

In accordance with an aspect of the present invention, there is provided a method for providing an MBMS in a mobile communication system, including: multiplexing MBMS traffic channels providing MBMS traffic data and an MBMS control channel proving control information of MBMS into a downlink-shared channel; processing and transmitting data of the downlink-shared channel to be transmitted through a physical downlink-shared channel of a physical channel; and generating and transmitting a physical downlink control channel which includes identifiers for indicating MBMS data and information to designate a receiving terminal of data transmitted through the physical downlink-shared channel.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a conceptual diagram explaining a channel configuration of a 3^{rd}-Generation Partnership Project (3GPP) Long-Term Evolution (LTE) Advanced system in accordance with an embodiment of the present invention.

FIG. 2 is a diagram of Media Access Control (MAC) Packet Data Unit (PDU) which is being discussed in the standard of a 3GPP LTE-Advanced system.

FIGS. 3A to 3C illustrate exemplar configurations of MAC sub-headers.

FIG. 4 is a conceptual diagram illustrating an apparatus of a base station for providing a Hybrid Automatic Repeat Request (HARQ)-type service and a general Multimedia Broadcast and Multicast Service (MBMS) service in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

According to the embodiment of the present invention a method of providing a Multimedia Broadcast and Multicast Service (MBMS) in the 3^{rd}-Generation Partnership Projects (3GPP) Long-Term Evolution (LTE) Advanced system will be explained. Here, a single-cell transmission system will be taken as an example of the embodiment of the present invention. However, it should be noted that it can be also applied to a multi-cell transmission system as well. The following three methods will be explained to provide the MBMS in the 3GPP LTE-Advanced system according to the present invention.

(1) A method of deciding Radio Network Temporary Identity (RNTI) for MBMS.

(2) A method of mapping MBMS traffic channel (MTCH) and MBMS control channel (MCCH) to a downlink-shared channel (DL-SCH).

(3) A method of service-customized retransmission for a group which uses Hybrid Automatic Repeat reQuest (HARQ) of MBMS data.

(1) A Method of Deciding RNTI for MBMS

First, a channel configuration of the 3GPP LTE-Advanced system according to the embodiment of the present invention will be described.

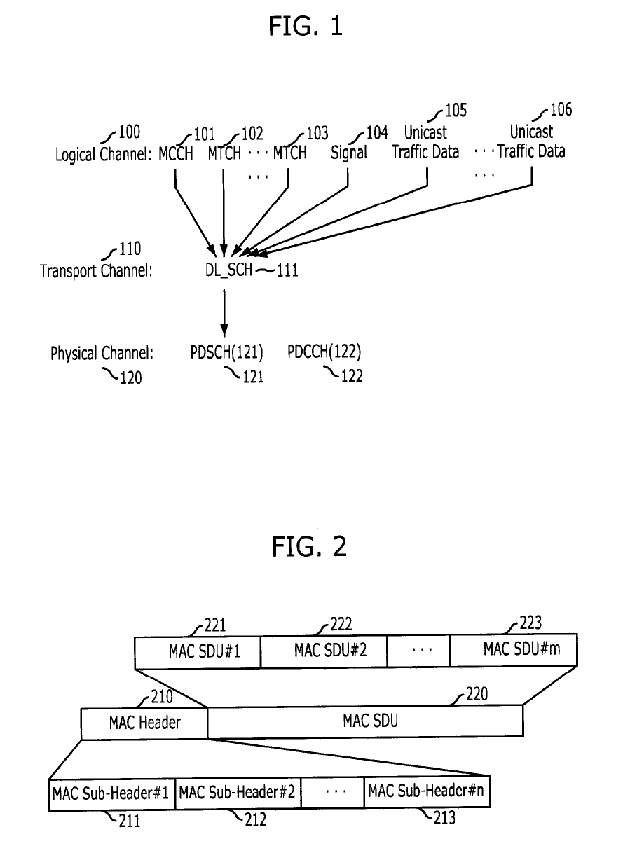

FIG. 1 is a conceptual diagram explaining a channel configuration of a 3GPP LTE-Advanced system according to an embodiment of the present invention.

The channels of the 3GPP LTE-Advanced system are divided into three channels, which are a logical channel 100, a transport channel 110, and a physical channel 120. In The logical channel 100, there are MBMS Traffic channels (MTCH) 102 to 103, which provide broadcasting services for transmitting MBMS data, and there is also MBMS Control Channel (MCCH) 101 for providing control information of MTCH. Also, the logical channel 100 includes unicast traffic data 105 to 106, the user service data provided to terminals and channels for transmitting signals. Such logical channel is transmitted through a downlink-shared channel (DL_SCH) 111 of the transport channel 110. That is, the MCCH 101, MTCH 102 to 103, signal 104, and unicast traffic data 105 to 106 are multiplexed into the DL_SCH 111. Although this is not shown in FIG. 1, it is also possible to realize the embodiment using a multiplexer. Also, data to be sent through the DL_SCH 111 of the transport channel 110 are transmitted through a physical downlink-shared channel (PDSCH) 121 of the physical channel 120. The PDSCH 121 is transmitted through a physical downlink-shared channel transmitting unit (not shown). In addition, a physical downlink control channel (PDCCH) 122 is transmitted through a physical downlink control channel transmitting unit (not shown).

That is, as data provided to the PDSCH 121, information all terminals can receive and data only transmitted to each terminal can be transmitted together. Accordingly, in order for each terminal to recognize the data provided to the PDSCH 121 as its own data, the 3GPP LTE-Advanced system defines the PDCCH 122. The PDCCH 122 indicates receiving terminals of the unicast traffic data 105 to 106, provided to terminals from the PDSCH 121, using RNTI for terminals which should receive data. That is, control information loaded to the PDCCH 122 of the 3GPP LTE-Advanced system is a channel for providing information to a terminal for receiving the PDSCH 121 or all terminals. Therefore, the RNTI is used for the PDCCH 122 assigned to a terminal receiving the PDSCH 121 as a factor for indicating terminals.

However, since a plurality of terminals have to receive the MBMS in common, there is a problem of not being able to indicate all terminals one by one. Accordingly, a method of indicating only the MBMS is required. According to the embodiment of the present invention, as a method of indicating the MBMS in the single cell for providing the MBMS, MBMS_RNTI is designated to be recognized in the cell in common. The MBMS_RNTI according to the embodiment of the present invention is transmitted as an L1/L2 control signal through the PDCCH 122 of the physical channel 120. In a transmission method, all terminals recognize the MBMS using the single-cell transmission method and receive MBMS traffic data from a PDSCH physical channel. The MBMS may be provided in the above transmission method.

The MBMS_RNTI according to the present invention uses an RNTI value which is not defined at present. That is, a reserved RNTI value is a value of 0xFFF3 to 0xFFFC. Accordingly, the MBMS_RNTI is set by selecting one of the values of 0xFFF3 to 0xFFFC of RNTI values.

A base station which transmits MBMS traffic using the MBMS_RNIT generates the PDCCH 122. While the PDCCH 122 is formed, the base station may generate the RNTI which is generally used to indicate which traffic to be provided to a certain terminal is included in the PDSCH 121. In this case, the PDCCH 122 includes an RNTI for indicating the MBMS and an RNTI for identifying the certain terminal. Such PDCCH 122 can be also generated in a unit, such as a physical controller (not shown in FIG. 1).

(2) A Method of Mapping MTCH and MCCH to DL_SCH

Here, a method of mapping the MTCH 102 to 103 and MCCH 101 of the logical channel 100 to the LD_SCH 111 of the transport channel 110 will be described according to a second embodiment of the present invention.

Sufficient MTCH should be secured to accept various MBMS sessions. According to the present standard of the 3GPP LTE-Advanced system, although a logical channel range is specified as 5 bits, MCCH and MTCH are not defined yet. Therefore, it is required to define a logical channel and determine its range to accept the MBMS in the present invention.

For the logical channel definition and mapping, MAC sub-header of MAC PDU should be studied first. FIG. 2 is a diagram of a MAC PDU which is being discussed for the standardization of 3GPP LTE-Advanced system.

First, the MAC PDU includes a MAC header 210 and a MAC SDU 220. The MAC header 210 has a plurality of MAC sub-headers 211 to 213, and the MAC SDU 220 has a plurality of MAC SDUs 221 to 223. The MAC sub-headers 211 to 213 correspond one-to-one to the MAC SDUs 221 to 223. However, the number of the MAC sub-headers and the number of the MAC SDUs may not be the same.

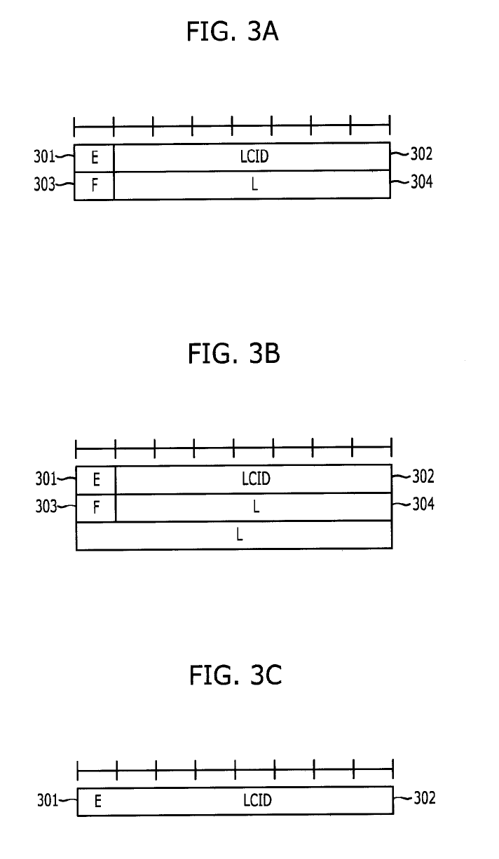

The configuration of the MAC sub-headers 211 to 213 will be explained by referring to FIGS. 3A to 3C.

FIGS. 3A to 3C illustrate exemplar configurations of the MAC sub-headers.

The MAC sub-header shown in FIG. 3A is an MBMS MAC sub-header having a 7-bit L field. The MAC sub-header shown in FIG. 3B is an MBMS MAC sub-header having a 15-bit L field. Finally, a MAC sub-header of FIG. 3A is an MBMS MAC sub-header for closing.

In FIG. 3A to FIG. 3C, a field E 301 indicates extension which signifies that it is followed by new sub-headers, a field F 303 shows an indicator telling whether an L field 304 is of 7 or 15 bits. The L field 304 uses a 7-bit field when MAC SDU is formed of less than 128 bytes, and uses a 15-bit field when it is formed of 128 bytes or more. Lastly, an LCID field 302 is a logical channel identifier. In the embodiment of the present invention, MCCH 101 and MTCH 102 to 103 are classified by the LCID field 302.

According to the present embodiment, “0000000” is assigned and used for the value of the LCID field 302 for the MCCH 101, while the LCID field 302 for the MTCH 102 to 103 takes a value of “0000001 to 1111110”.

Using such values, the MTCH buffer of a base station transmits data with a specific broadcasting cycle. That is, a MAC scheduler multiplexes each MBMS data stored in one or more MTCH buffers into the DL_SCH 111 of the transport channel 110. Also, the base station has a buffer for storing data to send the MCCH 101, and the MCCH buffer has a unique broadcasting cycle and can be multiplexed with the MTCH 102 to 103.

That is, in the present invention, terminals may selectively receive one of the MCCH 101 or MTCHs 102 to 103 at the DL_SCH 111 of the transport channel 110 which has been received through MBMS_RNTI in accordance with the embodiment of the present invention, which is relevant to a service to be offered.

(3) A Method of Service-Customized Retransmission for a Group which Uses HARQ (Hybrid Automatic Repeat Request) of MBMS Data.

A third embodiment of the present invention will describe a customized retransmission method for a group using HARQ among MBMS data. Generally, it is possible to request retransmission when there is an error in receiving data bound for a single specific terminal. Then, the base station retransmits the erroneous data, thereby increasing data reception efficiency through error correction made by the terminal. HARQ is one of such systems.

According to the present embodiment, HARQ is applied for a specific broadcasting group or broadcasting service among MBMS data. Therefore, the base station of the present embodiment allows a certain terminal group to receive a better service compared to a general terminal group using HARQ functions within the cell which provides the MBMS. When having MBMS service, such a terminal group requests retransmission and receives retransmit traffic data if there is an error in the received MBMS service, thereby correcting the data error and thus having a high quality service.

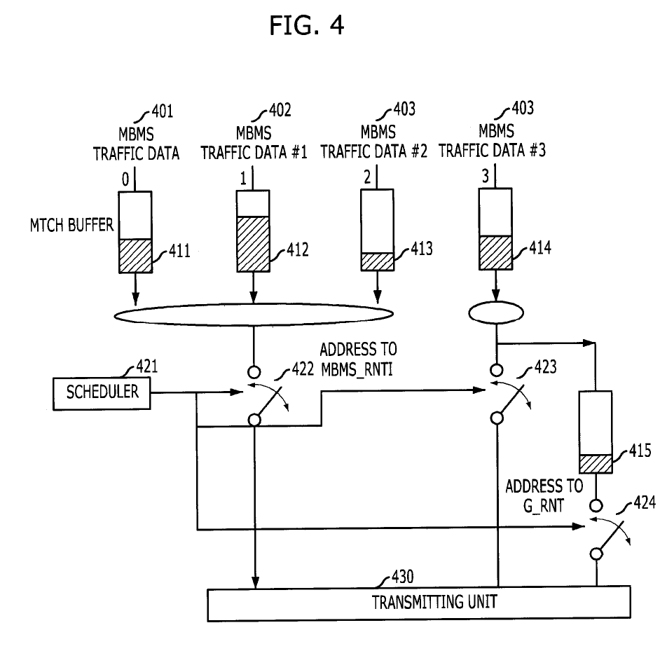

FIG. 4 is a conceptual diagram illustrating a unit of a base station for providing a HARQ-type service and a general MBMS service in accordance with an embodiment of the present embodiment, supposing that four types of MBMS traffic data 401, 402, 403, and 404 are received from an upper level.

The MBMS traffic data 401, 402, 403, and 404 are inputted to corresponding MTCH buffers 411, 412, 413, and 414, respectively. Here, the part of each buffer 411 to 414 marked with oblique lines shows data volume in a diagram. Also, it is supposed that the MBMS traffic data #0 to # 2 401 to 403 are general MBMS traffic data, while the MBMS traffic data #3 404 is traffic retransmitted in accordance with HARQ.

Accordingly, as explained in the first embodiment of the present invention, the PDCCH informs data transmission using MBMS_RNTI, and the MTCH buffers 411 to 413 for storing general MBMS traffic and the MTCH buffer 414 for storing retransmitted MBMS traffic are multiplexed into the DL_SCH 111 of the transport channel 110.

The general traffic stored in the MTCH buffers 411 to 413 and the HARQ-type-retransmitted traffic stored in the MTCH buffer 414 are provided to a transmitting unit 430 by which a scheduler 421 controls switches 422 and 423 based on a scheduling time. Accordingly, the transmitting unit 430 provides the general MBMS traffic to terminals through the PDSCH 121. Therefore, the traffic in HARQ according to the present embodiment has the same transmitting time and cycle as the general MBMS traffic.

Here, difference is that the MBMS traffic to which the HARQ is applied according to the present embodiment is stored in an MBMS retransmitting buffer 415 after transmission is made. The traffic stored in the MBMS retransmitting buffer 415 can be retransmitted upon a terminal's request for retransmitting the MBBMS traffic and it will be explained in detail.

The data stored in the MTCH buffer 414 which stores the MBMS traffic data #3 404 providing HARQ according to the present embodiment is stored in the MBMS retransmitting buffer 415. Afterwards, the MBMS traffic of HARQ can receive a request of transmission from a terminal. Such a request defines a group RNTI separately according to the present embodiment. That is, according to the present embodiment, a base station assigns a group RNTI (G_RNTI) for retransmission traffic data to a retransmission terminal group. The group RNTI (G_RNTI) uses an RNTI value which is not defined in the current 3GPP LET-Advanced system standard. This time, too, as explained previously in the first embodiment of the present invention, one of the values of 0xFFF3 to 0xFFFC is selected. Here, 0xFFF3 to 0xFFFC are RNTI values whose use is reserved in the standard of the 3GPP LTE-Advanced system. However, the selected value should be different from the RNTI used for the base station to indicate general MBMS. Afterwards, the retransmitted MBMS traffic is provided to the transmitting unit 430 by which the scheduler 421 controls the switch 424 at a scheduled time. Here, the retransmitted MBMS traffic can indicate MBMS traffic transmitted through the PDCCH 122 of the physical channel 120 using G_RNTI.

In this case, the terminal repeatedly retransmitted traffic data which is addressed to G_RNTI, thereby receiving a high quality MBMS service. Here in FIG. 4, only a single retransmission buffer is illustrated, but a plurality of retransmission buffers may be provided. That is, when an error of the MBMS traffic continuously occurs after retransmission is made one time, it can be arranged to request a repeat of transmission. In this case, the base station should have at least two retransmission buffers. Therefore, high-quality service can be provided by providing the MBMS service in this manner.

According to the embodiments of the present invention, it is possible to provide an apparatus and method for providing the MBMS in a wireless communication system, e.g., a 3GPP LTE-Advanced mobile communication system. The MBMS could not be provided in the 3GPP LTE-Advanced mobile communication system because the MBMS is not defined in the 3GPP LTE-Advanced mobile communication system. According to the embodiments of the present invention, it is also possible to provide large-volume MBMS.

While the present invention has been described with respect to the specific embodiments, it will be apparent to those skilled in the art that various changes and modifications may be made without departing from the spirit and scope of the invention as defined in the following claims.

What is claimed is:

1. A method for providing Multimedia Broadcast and Multicast Service (MBMS) in a mobile communication system, comprising:
multiplexing MBMS traffic channels providing MBMS traffic data and an MBMS control channel proving control information of MBMS into a downlink-shared channel;
processing and transmitting data of the downlink-shared channel to be transmitted through a physical downlink-shared channel of a physical channel; and
generating and transmitting a physical downlink control channel which includes identifiers for indicating MBMS data and information to designate a receiving terminal of data transmitted through the physical downlink-shared channel.

2. The method of claim 1, further comprising;
multiplexing traffic provided to a specific terminal together when the MBMS traffic channels and MBMS control channel are multiplexed into the physical downlink-shared channel,
wherein the physical downlink control channel further comprises an identifier for indicating traffic provided to the specific terminal.

3. The method of claim 1, wherein the control information of the MBMS identifies the MBMS control information and MBMS traffic information based on a logical channel identifier of a Media Access Control (MAC) sub-header.

4. The method of claim 1, further comprising:
storing MBMS traffic in a retransmission buffer when transmitting the MBMS traffic which is retransmittable.

5. The method of claim 4, further comprising:
retransmitting the MBMS traffic stored in the retransmission buffer through the physical downlink-shared channel when the retransmittable MBMS traffic is requested to be retransmitted; and
transmitting an identifier provided for indicating the MBMS traffic which is retransmitted to the physical downlink-shared channel to the physical downlink control channel.

6. An apparatus for providing an MBMS in a mobile communication system, comprising:
a multiplexer configured to multiplex MBMS traffic channels providing MBMS traffic data and an MBMS control channel providing control information of the MBMS into a downlink-shared channel;
a scheduler configured to schedule transmission of the MBMS traffic data and the control information of the MBMS;
a physical downlink-shared channel transmitting unit configured to process data of the physical downlink-shared channel to be transmitted through a physical downlink-shared channel of a physical channel; and
a physical downlink control channel transmitting unit configured to generate and transmit a physical downlink control channel which includes identifiers for indicating MBMS data and information for designating a receiving terminal of data transmitted through the physical downlink-shared channel.

7. The apparatus of claim 6, wherein the multiplexer multiplexes traffic provided to a specific terminal together during the multiplexing into the physical downlink-shared channel, and the physical downlink control channel transmitting unit further includes an identifier for indicating traffic provided to the specific terminal.

8. The apparatus of claim 6, wherein the control information of the MBMS identifies the MBMS control information and MBMS traffic information based on a logical channel identifier of a Media Access Control (MAC) sub-header.

9. The apparatus of claim 6, further comprising:
a retransmission buffer configured to store MBMS traffic transmitted when retransmittable MBMS traffic which is retransmitted.

10. The apparatus of claim 9, wherein the scheduler performs scheduling in such a manner that the MBMS traffic stored in the retransmission buffer is retransmitted through the physical downlink-shared channel transmitting unit when the retransmittable MBMS traffic is requested to be retransmitted, and the physical downlink control channel transmitting unit transmits an identifier provided for indicating the MBMS traffic which is retransmitted to the physical downlink-shared channel transmitting unit.
